(19) United States
(12) Patent Application Publication
(10) Pub. No.: US 2025/0231127 A1
(43) Pub. Date: Jul. 17, 2025

(54) ELEMENTAL IDENTIFICATION BASED ON PHASE ANALYSIS

(71) Applicant: FEI Company, Hillsboro, OR (US)

(72) Inventors: Marek Vanatka, Brno (CZ); Chris Stephens, East Grinstead (GB); Petr Hlavenka, Brno (CZ); Jakub Klus, Brno (CZ)

(21) Appl. No.: 18/413,850

(22) Filed: Jan. 16, 2024

(51) Int. Cl. G01N 23/2209; G01N 23/2251; G06T 7/11; G06T 7/143

(52) U.S. Cl. CPC G01N 23/2209; G01N 23/2251; G06T 7/11; G06T 7/143; G01N 2223/304; G06T 2207/10061

(57) ABSTRACT

In some embodiments, a support apparatus for a scientific instrument includes an interface device configured to receive a dataset including a charged-particle-microscope (CPM) image of a sample and a plurality of energy-dispersive X-ray spectroscopy (EDS) spectra of the sample. Each of the EDS spectra corresponds to a respective pixel of the CPM image. The support apparatus also includes one or more electronic processing devices configured to: compute a phase map of the sample by applying phase analysis to the dataset, the phase map identifying groups of pixels representing different respective phases of the sample; for each group of the identified groups of pixels, determine a respective element set based on the EDS spectra corresponding to the group; and for a selected chemical element, compute a corresponding elemental map of the sample based on the identified groups of pixels and the determined respective element sets.

### TECHNICAL FIELD

Various examples relate generally, but not exclusively, to charged particle microscopy components, instruments, systems, and methods.

### SUMMARY

Energy-dispersive X-ray spectroscopy (EDS, also abbreviated as EDX or XEDS) is an analytical technique used for chemical characterization and elemental analysis of materials. A sample excited by an energy source dissipates some of the absorbed energy by ejecting core-shell electrons. An outer-shell electron proceeds to fill the vacancy, releasing the difference in energy as an X-ray photon. The spectral composition of the emitted X-ray photons is characteristic to the atom of origin. As such, X-ray spectra measured in this manner allow for the compositional analysis of a sample volume excited by the energy source. Positions of the peaks in the spectrum identify the element, whereas the intensity of the signal represents the concentration of the element in the corresponding volume.

The electron beam of an electron microscope provides sufficient energy to eject core-shell electrons and cause X-ray emission. As the electron beam is scanned across the sample, characteristic X-rays are emitted and measured with a suitable EDS detector. Each recorded EDS spectrum is then mapped to a respective pixel location on the sample. The quality of subsequent elemental identification typically depends on the signal strength and the signal-to-noise ratio (SNR). The SNR can be increased, for example, by properly binning the recorded EDS spectra corresponding to different pixel locations. However, for at least some samples, some types of binning may result in a relatively low accuracy of elemental identification. For example, for a small particle that occupies a small number of pixels in the field of view (FOV), some constituent elements may disadvantageously be missed during automated identification of a binned spectrum due to the corresponding peaks being buried in the spectrum's background.

Disclosed herein are, among other things, various examples, aspects, features, and embodiments of a scientific instrument including a charged-particle-microscope (CPM) and associated detectors for acquisition of electron-microscope images and pixelwise EDS spectra. In one example, an electronic controller of the scientific instrument runs phase analysis in the background of the ongoing acquisition process and computes phase spectra for different phases identified via the phase analysis by binning the corresponding pixelwise EDS spectra. The electronic controller then computes preliminary elemental maps of the sample based on the phase map and the phase spectra. The elemental maps may be updated live as new measurements are received from the detectors.

One example provides an automated method performed via a computing device for providing support to a scientific instrument, the method comprising: computing a phase map of a sample by applying phase analysis to a dataset including a CPM image of the sample and a plurality of EDS spectra of the sample, with each of the EDS spectra corresponding to a respective pixel of the CPM image, the phase map identifying groups of pixels representing different respective phases of the sample; for each group of the identified groups of pixels, determining a respective element set based on the EDS spectra corresponding to the group; and for a selected chemical element, computing a corresponding elemental map of the sample based on the identified groups of pixels and the determined respective element sets.

Another example provides a non-transitory computer-readable medium storing instructions that, when executed by a computing device, cause the computing device to perform operations comprising the above automated method.

Yet another example provides a support apparatus for a scientific instrument, the support apparatus comprising: an interface device configured to receive a dataset including a CPM image of a sample and a plurality of EDS spectra of the sample, with each of the EDS spectra corresponding to a respective pixel of the CPM image; and one or more electronic processing devices configured to: compute a phase map of the sample by applying phase analysis to the dataset, the phase map identifying groups of pixels representing different respective phases of the sample; for each group of the identified groups of pixels, determine a respective element set based on the EDS spectra corresponding to the group; and for a selected chemical element, compute a corresponding elemental map of the sample based on the identified groups of pixels and the determined respective element sets.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings.

FIG. 1 is a block diagram illustrating an example scientific instrument in accordance with some embodiments.

FIG. 2 is a block diagram illustrating a portion of the scientific instrument of FIG. 1 in accordance with one embodiment.

FIGS. 3-5 are diagrams illustrating different energy-dispersive X-ray spectroscopy (EDS) binning configurations used in the scientific instrument of FIG. 1 according to some examples.

FIG. 6 is a flowchart illustrating a method of elemental auto identification according to some embodiments.

FIG. 7 graphically shows a scanning electron microscope (SEM) image generated with the scientific instrument of FIG. 1 according to one example.

FIGS. 8A and 8B graphically show maps of two phases identified in the SEM image of FIG. 7 with the method of FIG. 6 according to one example.

FIGS. 9A and 9B graphically show phase spectra of the two phases illustrated in FIGS. 8A and 8B computed using the method of FIG. 6 according to one example.

FIG. 10 is a flowchart illustrating a method of elemental auto identification according to one embodiment.

FIG. 11 is a block diagram of an example computing device configured to perform at least some scientific-instrument support operations in accordance with various embodiments.

### DETAILED DESCRIPTION

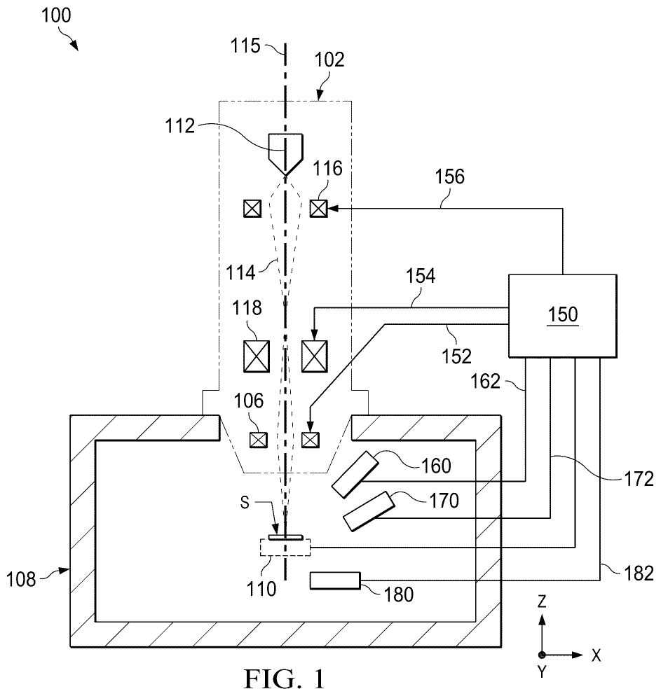

FIG. 1 is a block diagram illustrating a scientific instrument 100 in accordance with some embodiments. The scientific instrument 100 includes a charged-particle beam column 102 coupled to a vacuum chamber 108. In some examples, the charged-particle beam column 102 is a scanning electron microscope (SEM) column, a scanning transmission electron microscope (STEM) column, or a focused ion-beam (FIB) column. The vacuum chamber 108 houses a movable sample holder 110 and can be evacuated using one or more vacuum pumps (not explicitly shown in FIG. 1). In an example embodiment, the sample holder 110 is independently movable parallel to the XY-coordinate plane and parallel to the Z-coordinate axis, with the corresponding coordinate system being indicated by the XYZ-coordinate triad shown in FIG. 1. In some embodiments, the sample holder 110 is movable with six degrees of freedom including tilt in one or more rotational directions. A sample S to be interrogated using the scientific instrument 100 is mounted in the sample holder 110.

In one example, the (SEM-type) charged-particle beam column 102 comprises an electron source 112 and two or more charged-particle-beam (CPB) lenses, only two of which, for example, an objective lens 106 and a condenser lens 116, are schematically shown in FIG. 1 for illustration purposes. In some examples, a different (from two) number of such lenses may be used in the SEM column 102.

In operation, the electron source 112 generates an electron beam 114 propagating generally along a longitudinal axis 115 of the SEM column 102. CPB lenses 106 and 116 are operated to generate electric and magnetic fields that affect electron trajectories in the electron beam 114. Control signals 152, 156 generated by an electronic controller 150 are used to change the strengths and/or spatial configurations of the fields and impart desired properties on the electron beam 114. In general, the CPB lenses 106 and 116, control signals 152 and 156, and other pertinent components of the scientific instrument 100 can be used to perform various operations and support various functions, such as beam focusing, aberration mitigation, aperture cropping, filtering, etc. The SEM column 102 further comprises a deflection unit 118 that can steer the electron beam 114 in response to a drive signal 154 applied thereto via the electronic controller 150. Such beam steering can be used to move a focused portion of the electron beam 114 to a selected spot on the sample S or along a desired path across the sample S. In an example implementation of the imaging mode, the drive signal 154 changes over time to move the focused portion of the electron beam 114 across the sample S in a raster or other suitable scan pattern.

In another example, the (FIB-type) charged-particle beam column 102 comprises an ion source 112 and ion-beam optics 106, 116, 118. In some instances, the ion source 112 is a plasma source connected to a plurality of gas volumes (not explicitly shown). The gas volumes are individually connectable to the plasma source via respective valves to select individual gases stored in the gas volumes or make mixtures thereof for the ion source. Example gases supplied to the ion source 112 in this manner are xenon, argon, oxygen, hydrogen, and nitrogen gases. In operation, the ion source 112 ionizes the supplied gas(es), thereby forming a plasma. Ions extracted from the plasma are accelerated through the FIB column 102 to form an ion beam 114 propagating generally along a longitudinal axis 115 of the FIB column 102. The ion-beam optics 106, 116, 118 may be used, among other things, to focus the ion beam 114 at the sample S and to move a focused portion of the ion beam 104 along a desired path across the sample S, such as, for example, to perform a raster or vector scan of the sample S. In some other instances, the ion source 112 may comprise a liquid metal ion source (LMIS) or any other ion source compatible with the FIB column 102. In various configurations of the FIB column 102, the ion beam 114 may be used to perform imaging of the sample S or machining operations, such as, for example, incising, milling, etching, depositing, and the like.

The scientific instrument 100 also includes detectors 160, 170, 180 located in the vacuum chamber 108 in relatively close proximity to the sample S. In operation, the detectors 160, 170, and 180 generate streams of measurements 162, 172, and 182 that are received by the electronic controller 150. Specific types of the detectors 160, 170, 180 depend on the embodiment of the scientific instrument 100 and can typically be chosen from a variety of detector types suitable for detecting different types of emission and/or radiation from the sample S produced thereby in response to the electron beam 114. Example types of the emission/radiation that can be produced in this manner include, but are not limited to, X-rays, infrared light, visible light, ultraviolet light, back-scattered electrons, secondary electrons, Auger electrons, elastically scattered electrons, non-scattered (e.g., zero energy loss) electrons, and non-elastically scattered electrons. In various embodiments, a different (from three) number of such detectors can be used. In some embodiments, the detectors 160, 170, 180 are selected from the group consisting of a high-angle annular dark field detector, a medium-angle annular dark field detector, an annular bright field detector, a segmented annular detector, a differential phase contrast detector, an electron energy loss spectroscopy (EELS) detector, an EDS detector, and a two-dimensional pixelated diffraction-pattern detector. Other detectors capable of detecting various ones of the above-mentioned types of emission/radiation can also be used in various additional embodiments.

In the example shown, the detectors 160, 170 are positioned above the sample S, and the detector 180 is positioned below the sample S. Herein, the terms “above” and “below” are used relative to the propagation direction of the electron beam 114, which propagates generally along the Z-coordinate axis, from the electron source 112 toward the sample S. In this sense, locations that are “above” the sample S have a non-zero offset from the sample S along the Z-coordinate axis in the upstream direction of the electron beam 114. Similarly, locations that are “below” the sample S have a non-zero offset from the sample S along the Z-coordinate axis in the downstream direction of the electron beam 114. In various additional embodiments, different numbers of detectors can be located above and below the sample S. In some embodiments, all such detectors can be located below or above the sample S.

In some examples, the scientific instrument 100 is a dual-beam instrument that includes first and second instances of the charged-particle beam column 102 coupled to the vacuum chamber 108. In such examples, the first instance is the above-described SEM-type charged-particle beam column 102, and the second instance is the above-described FIB-type charged-particle beam column 102. In various geometric arrangements, the longitudinal axes 115 of the SEM-type and FIB-type charged-particle beam columns 102 are oriented with respect to one another at an angle between approximately 30 degrees and 60 degrees.

For illustration purposes and without any implied limitations, example embodiments are described below in reference to the scientific instrument 100 equipped with a SEM column 102 or with a STEM column 102. Based on the provided description, a person of ordinary skill in the pertinent art will be able to make and use other embodiments suitable for use with other configurations of the scientific instrument 100 without undue experimentation. In particular, the scientific instrument 100 is configured to obtain charged particle microscope images of samples including SEM images, FIB images, and/or STEM images.

In general, various embodiments disclosed herein can be used with charged-particle microscopy (CPM) systems and instruments designed for electron microscopy and/or focused-ion-beam microscopy, including dual-beam systems and instruments. Example ion sources used in FIB columns include, but are not limited to, the sources of H, He, Ar, Ne, and Ga ions. The corresponding systems may typically provide the capability for sub-10 nm patterning, as well as imaging of non-conductive and magnetic samples.

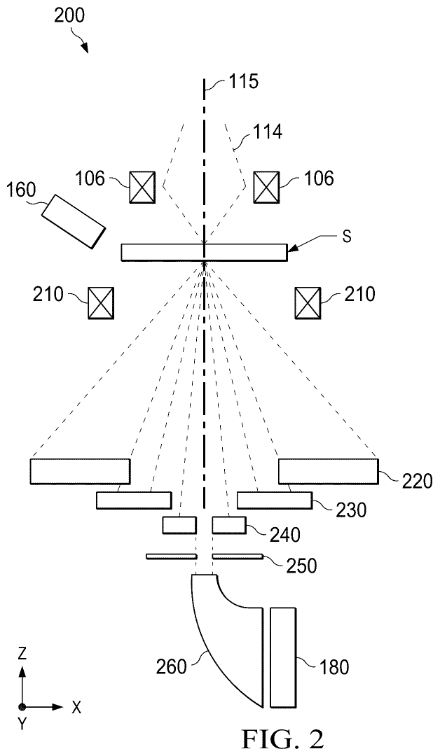

FIG. 2 is a block diagram illustrating a portion 200 of the scientific instrument 100 in accordance with one example embodiment. The portion 200 is an illustrative example of a detector configuration suitable for combined use of spectroscopy and microscopy in the scientific instrument 100. Both spectroscopy and microscopy are useful tools for sample analyses individually, but when combined, spectroscopy and microscopy can yield even more powerful results. In the example shown, the portion 200 provides a STEM imaging capability. The spectroscopy techniques implemented in the portion 200 include, but are not limited to, Electron Energy Loss Spectroscopy (EELS) and Energy-Dispersive X-ray Spectroscopy (EDS).

The portion 200 includes the objective lens 106, the sample S, and the detectors 160, 180 also shown in FIG. 1. The portion 200 further includes a projector lens 210, one or more annular detectors 220, 230, and 240, an aperture 250, and a magnetic field sector 260. FIG. 2 also schematically shows the electron beam 114 delivered to the sample S as described above in reference to FIG. 1. The STEM imaging modality of the scientific instrument involves sequential scans of a focused portion of the electron beam 114 over a selected part of the sample S with the use of some or all of the annular detectors 220, 230, and 240, which select electrons with different scattering angles with respect to the propagation direction of the electron beam 114. Pixel-by-pixel data acquisition carried out in this manner is used, among other things, to construct STEM images of the scanned area of the sample S.

In some examples, the annular detector 220 is a high-angle annular dark field (HAADF) detector configured for detection of incoherent quasi-elastic electron scattering by nuclei, which is usually a dominant component for scattering angles higher than 80 mrad. Similarly, in some examples, the annular detector 230 is a medium-angle annular dark field (MAADF) detector configured to detect electrons with scattering angles between approximately 30 and 80 mrad, and the annular detector 240 is an annular bright field (ABF) detector configured to detect electrons at low scattering angles.

Various electron-microscopy-based spectroscopic techniques are typically directed at obtaining quantitative and/or qualitative information from various signals generated during the scanning of the electron beam 114 over the sample S. After proper collection, the spectroscopic signals can be used for the construction of maps of material properties to be presented together with or overlaid onto the corresponding electron-microscopy images, such as, for example, images generated as indicated above with one or more of the annular detectors 220, 230, and 240 and/or other suitable detectors. In various examples of the present disclosure, phase maps or elemental maps described herein can include graphical representations of phase or elemental information (i.e., images) or data arrays that associate phase or elemental information with individual image pixels or with groupings of image pixels.

In some examples, the detector 160 operates as an EDS detector, which is configured to detect emission of characteristic X-rays from the sample S stimulated by the electron beam 114. In the ground (unexcited) state, an atom within the sample S has its electrons in discrete energy levels of the atom's inner electron shells. Interaction of the electron beam 114 with the atom may cause an electron to be ejected from an inner shell of the atom, thereby creating an electron hole (vacancy). A recombination of this electron hole with an electron from an outer shell of the atom causes an emission of an X-ray photon. The flux of such X-ray photons and their energies are measured by the EDS detector 160, which thereby measures the corresponding X-ray emission spectrum. Since each chemical element has a unique set of peaks in the X-ray emission spectrum, analyses of the X-ray spectra measured by the EDS detector 160 can be used to reveal the elemental composition of the sample S. The elemental composition can also be referred to as an element set. The elemental composition or element set includes an identification of one or more elements present in the sample and, in some cases, relative compositional proportions between the elements present in the sample.

In some examples, the detector 180 operates as an EELS detector, which is configured to detect inelastically scattered electrons of the electron beam 114 propagating within a narrow range of angles selected by the aperture 250. The electrons that pass through the aperture 250 further pass through the magnetic field sector 260 wherein the electrons are angularly dispersed by the magnetic field before impinging onto the EELS detector 180. Different pixels of the EELS detector 180 thus receive electrons of different respective energies, with the pixel readout providing a corresponding energy-loss spectrum. The amount of energy loss measured in this manner can be interpreted in terms of what caused the energy loss. For example, inelastic interactions that can cause energy losses detectable by the EELS detector 180 include phonon excitations, inter- and intra-band transitions, plasmon excitations, inner shell ionizations, and Cherenkov radiation. The inner-shell ionizations, as detected by the EELS detector 180, may be particularly useful for detecting the elemental composition of the sample S.

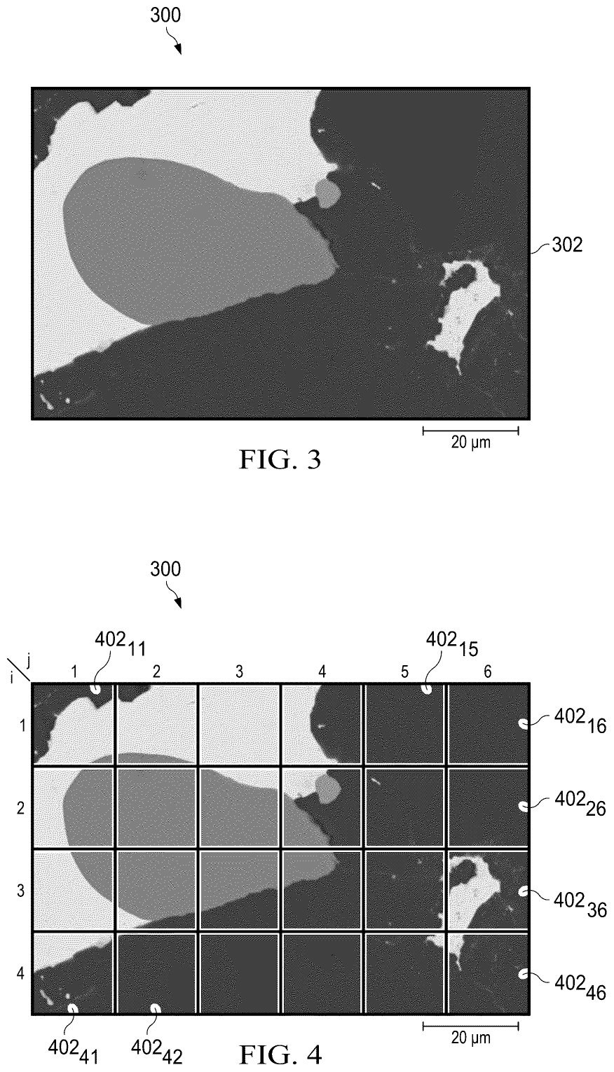

FIGS. 3-5 are diagrams illustrating different EDS binning configurations that can be used in the scientific instrument 100 according to some examples. In the examples shown, each of the illustrated binning configurations is applied to a same SEM image 300 of the sample S. The size of the SEM image 300 is 720×1080 pixels². Each pixel of the SEM image 300 has a corresponding EDS spectrum associated with it, and the corresponding data structure is referred to as the spectrum-image data hypercube. In other examples, SEM images may have other numbers of pixels.

The binning configuration illustrated in FIG. 3 has a single bin 302 that is of the same size as the whole SEM image 300. The EDS spectrum corresponding to the bin 302 is computed by summing the EDS spectra of all pixels of the SEM image 300 (the total of 777,600 EDS spectra).

The binning configuration illustrated in FIG. 4 has 24 bins 402ᵢⱼ arranged in four rows and six columns, where i=1, 2, 3, 4 and j=1, 2, . . . , 6. Each of the bins 402ᵢⱼ has a square shape with the size of 180×180 pixels². The EDS spectrum corresponding to the bin 402ᵢⱼ is computed by summing the EDS spectra of its pixels (i.e., a total of 32,400 respective EDS spectra per bin). A spectrum output corresponding to this binning configuration includes 24 different EDS spectra computed in this manner.

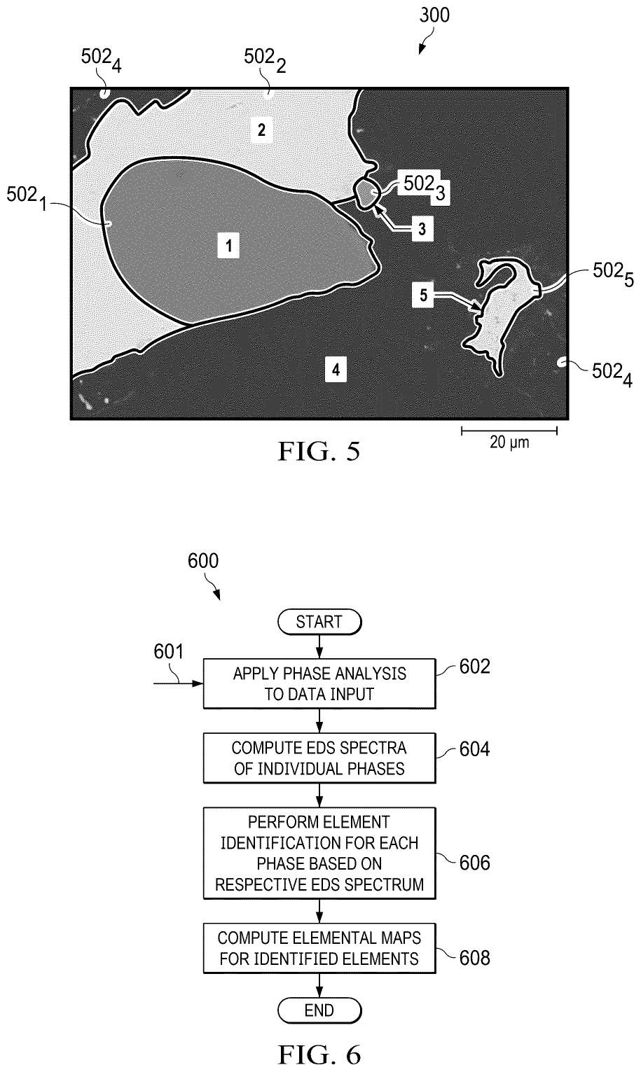

The binning configuration illustrated in FIG. 5 has five bins 502ₙ, where n=1, 2, . . . , 5. Each of the bins 502ₙ has a respective irregular shape overlaying the area of a corresponding phase of the sample S in the SEM image 300. As used herein, the term “phase” refers to a region of the sample S that is substantially chemically uniform, physically distinct, and sometimes mechanically separable. The term “phases” is not synonymous with the term “states of matter.” For example, a sample of solid iron may contain multiple solid phases, such as ferrite, martensite, austenite, and the like. In a representative example, a phase is a region of space of the sample S in which a selected set of material properties is substantially uniform. In some examples, such set of material properties includes one or more of chemical composition, density, index of refraction, or magnetization.

In some examples, a computing device associated with the scientific instrument 100, such as, for example, the electronic controller 150 (FIG. 1), is configured to apply multivariate statistical analysis (MSA) methods to extract, from the spectrum-image data hypercube, statistical groups that can be interpreted as phases. The pixels of the SEM image 300 corresponding to different respective phases identified in this manner are grouped together to form different ones of the bins 502ₙ. In some examples, the areas of the SEM image 300 corresponding to the different bins 502ₙ are pseudo-colored for more-convenient visualization on a display device.

Software that can provide phase identification by analyzing, without human intervention, an inputted spectrum-image data hypercube is commercially available. Some instances of such software incorporate certain features disclosed in U.S. Pat. Nos. 6,584,413 and 6,675,106, both of which are incorporated herein by reference in their entireties. Various X-ray based phase identification and mapping methods are reviewed, for example, in John J. Friel and Charles E. Lyman, “X-ray Mapping in Electron-Beam Instruments,” Microscopy and Microanalysis, 2006, v. 12, pp. 2-25, which is incorporated herein by reference in its entirety. In some examples, at least some of such methods are implemented in software and executed by a computing device associated with the scientific instrument 100 to provide the type of phase mapping illustrated in FIG. 5.

In the example shown, the phase-identification and mapping software run on the electronic controller 150 has identified five different phases (labeled 1, 2, . . . , 5) in the sample S. The corresponding bins are the bins 502₁-502₅. The EDS spectrum corresponding to an individual bin 502n is computed by summing up the EDS spectra of its pixels. An output corresponding to this binning configuration includes five different EDS spectra, each corresponding to a bin computed in this manner.

In the example shown, the binning configuration illustrated in FIG. 5 is not obtainable via segmentation of the SEM image 300 based solely on the image contrast. For example, the phases 1 and 3 have similar contrast values but different chemical compositions. Unlike the contrast values, different EDS spectra unambiguously point to different respective phases, which enables segmentation of the SEM image 300 into the phases indicated in FIG. 5.

FIG. 6 is a flowchart illustrating a method 600 of elemental identification. The method 600 is implemented in the scientific instrument 100 according to some embodiments. In other embodiments, the method 600 (or portions thereof) may be implemented via one or more computing devices remote from the instrument 100. In different examples, the method 600 is executed offline or online. In an offline configuration, an input 601 to the method 600 includes a previously acquired spectrum-image data hypercube corresponding to the sample S, with the acquisition process already completed. In an online configuration, the input 601 includes a partially acquired or nonfinal spectrum-image data hypercube corresponding to the sample S that is currently being interrogated in the scientific instrument 100.

The method 600 includes applying phase analysis to the input 601 (in a block 602). In some examples, the phase analysis applied in the block 602 uses an MSA-based method of phase identification and phase mapping implemented in software. One example of a phase map generated in the block 602 is illustrated in FIG. 5.

The method 600 also includes computing respective EDS spectra of individual phases (in a block 604). In some examples, the phase spectrum of an individual phase identified in the block 602 is computed in the block 604 by summing the pixelwise EDS spectra of the corresponding bin of the SEM image (e.g., one of the bins 502₁-502₅ of the SEM image 300, FIG. 5). In the example illustrated in FIG. 5, five phase spectra corresponding to the phases 1-5, respectively, are computed in the block 604.

The method 600 also includes performing element identification for each of the individual phases (in a block 606). The element identification for an individual phase is performed in the block 606 based on the respective phase spectrum computed in the block 604. In some examples, the element identification includes the following operations: (i) finding one or more peaks in the phase spectrum; (ii) determining the spectral position(s) of the found peak(s); (iii) measuring an intensity of each of the found peak(s); and (iv) identifying one or more chemical elements based on the spectral positions and intensities of the peaks.

In some examples of the block 606, peaks in the phase spectrum are located by passing a “top-hat digital filter” through the phase spectrum channel-by-channel. One effect of this filter is to reduce the background portion of the spectrum to a level near zero while substantially preserving the peaks. As the program filters each point in the spectrum, a check is made to determine whether the filtered point is positive and significantly above the background points scattered about the zero level. When these conditions are met, then a peak is found, and an estimate of the peak's position is made by calculating the centroid of the points in the positive lobe of the filtered peak. After the peak is located, the peak's energy is determined.

In some examples of the block 606, the program calculates a peak intensity based on an estimate of the net counts in a located peak from the total counts in the peak's positive lobe in the filtered spectrum. In some other examples of the block 606, the program calculates a peak intensity by least squares fitting the filtered peak to a suitable peak function and then computing the area under the resulting fitted peak function. In other examples, other suitable methods of computing a peak intensity can be used.

In some examples of the block 606, the program examines the peak list of the phase spectrum, such as, for example, in the order of decreasing intensity, to find which X-ray energies match the peak energy within a specified tolerance (which is a parameter of the algorithm). During this matching process, certain rules are followed concerning the peaks that are expected to be present under the applicable EDS acquisition conditions. For example, X-ray energies above the acceleration energy of the electron beam are excluded, and K-beta peaks can only be present when the corresponding K-alpha peak is also present, and the like. The matching process can use a library of reference spectra corresponding to different elements of the periodic table of elements. When a match to a reference spectrum is found, the corresponding element is deemed to be present in the phase that is being analyzed. The relative concentrations of different elements in the phase may be estimated based on the relative intensities of the respective peak sets.

The method 600 also includes computing one or more elemental maps (in a block 608). In some examples, operations of the block 608 include: (i) merging the element identification results of different individual phases to cover areas corresponding to two or more phases of the sample; (ii) for each identified element, determining a corresponding set of pixels in the merged results for which the element is deemed to be present in the block 606; and (iii) generating an elemental map for an identified element by color-coding the corresponding set of pixels and overlaying the color-coded set of pixels on the corresponding SEM image. In response to suitable input from the user, individual elemental maps generated in this manner may be rendered and displayed for viewing via a user interface.

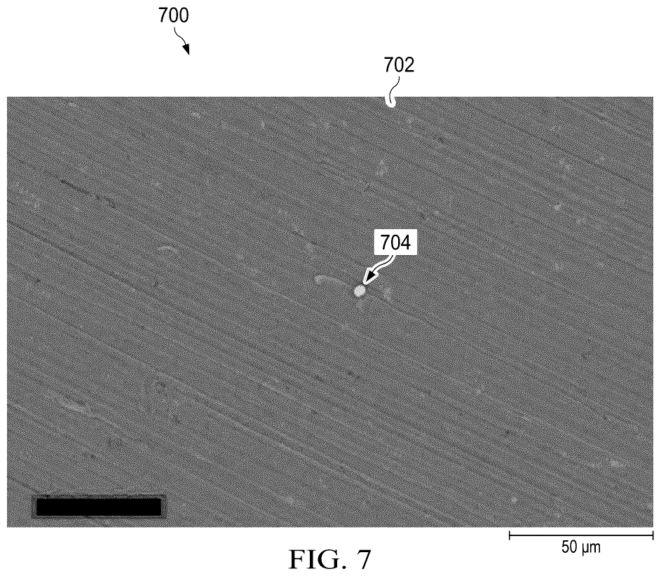

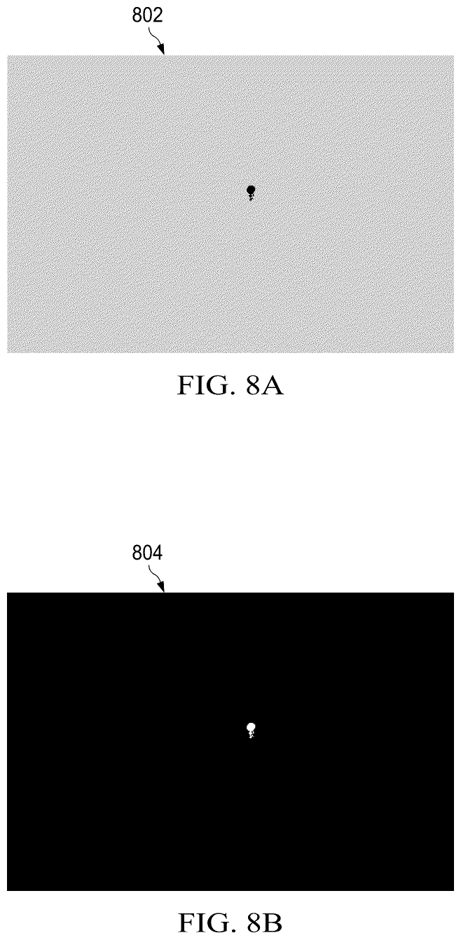

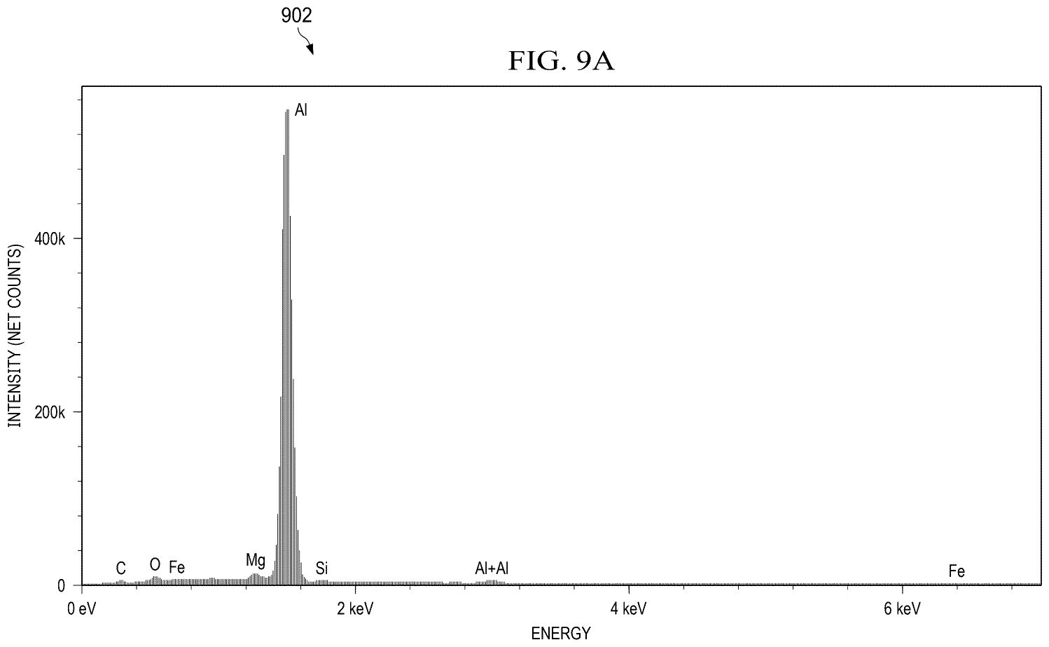

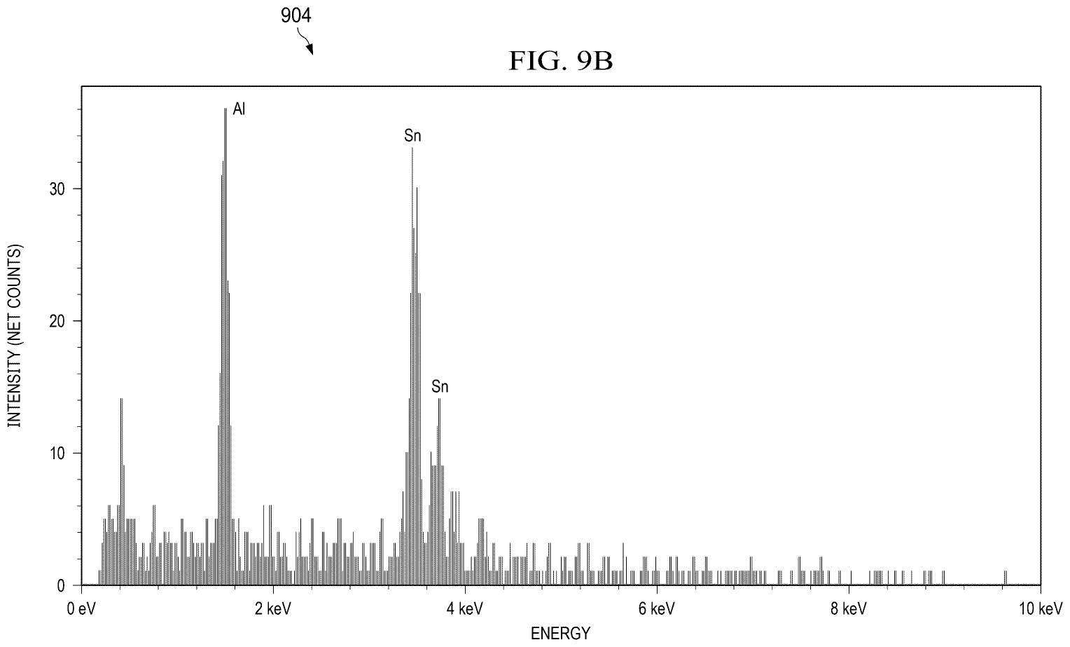

FIGS. 7, 8A, 8B, 9A, and 9B are graphs illustrating the method 600 according to one example. More specifically, FIG. 7 shows an example SEM image 700 of the sample S generated with the scientific instrument 100. FIGS. 8A and 8B show maps 802 and 804, respectively, of two phases identified in the SEM image 700 in the block 602 of the method 600. FIGS. 9A and 9B show phase spectra 902 and 904, respectively, computed in the block 604 of the method 600. The phase spectra 902 and 904 correspond to the two phases illustrated in FIGS. 8A and 8B, respectively.

The sample S shown in the SEM image 700 includes a small particle 704 on a substantially uniform substrate 702. The phase maps 802 and 804 identified for the SEM image 700 in the block 602 of the method 600 correspond to the substrate 702 and the particle 704, respectively. The phase spectra 902, 904 computed in the block 604 of the method 600 also have element labels inserted therein based on the element identification performed in the block 606 of the method 600. Based on that element identification, a dominant element for the substrate 702 is aluminum (Al). Dominant elements for the particle 704 are aluminum and tin (Sn). Note that the signal intensity (net counts) in the phase spectrum 904 is generally many orders of magnitude lower than the signal intensity (net counts) in the phase spectrum 906. For comparison, when either of the binning schemes illustrated in FIGS. 3 and 4 is used on the spectrum-image hypercube corresponding to the SEM image 700, tin is not identified as one of the elements present in the corresponding sample S by an automatic element identification algorithm. The misidentification occurs because the binning schemes in FIGS. 3 and 4 mix information from pixels corresponding to different phases. As a result, the spectral information from the dominant phase (having a significantly greater pixel count) substantially swamps the spectral information from the lesser phase (having a smaller pixel count), and the spectral information from the lesser phase can, for example, become lost in the background noise. Hence, this comparison clearly illustrates the utility and example benefits of the method 600 for at least some samples.

For some samples, the binning scheme of FIG. 4 can also cause misidentification due to an overlap of the Ka and Kb spectral peaks of different elements. For example, the Kb peak of titanium (Ti) and the Ka peak of vanadium (V) have similar energies, which causes these peaks to partially overlap in the EDS spectra of the bins that contain both elements. Because the Ka peak is typically about 5 times more intense, information represented by the coincident Kb peak can disadvantageously be lost with the binning scheme of FIG. 4. In contrast, this undesirable outcome is significantly less probable with the binning scheme of FIG. 5 and the method 600.

Although the above-described illustrative examples have a relatively small number (<6) of distinct phases in the sample S, the method 600 is not so limited. For example, the method 600 can also be used for samples that have a larger (than five) number of phases. In some examples, the corresponding sample S may have more than ten or more than one hundred phases. In some examples, the method 600 can also be adapted for particle analysis for samples S in which the number of small particles in the area of interest is in the range between one and 105. In such examples, the number of phases may be smaller than the number of particles.

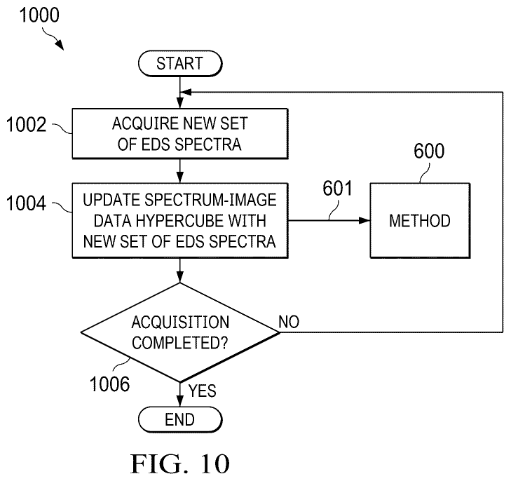

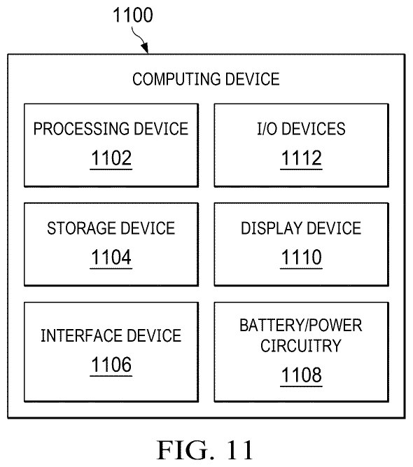

FIG. 10 is a flowchart illustrating a method 1000 of elemental identification. The method 1000 is implemented in the scientific instrument 100 according to one embodiment. However, in other embodiments, the method 1000 (or portions thereof) may be implemented via one or more computing devices remote from the scientific instrument 100. In various examples, the method 1000 is executed online while the data acquisition process is ongoing. The method 1000 incorporates an embodiment of the method 600 as a part thereof as explained in more detail below.

One parameter of the spectrum-image data hypercube acquisition process is dwell time, the value of which determines for how long the electron beam 114 remains at each scan pixel location while the X-ray detector 160 is accumulating the EDS spectrum corresponding to that location. Depending on the selected value of dwell time, the final spectrum-image data hypercube can be acquired in many different ways. For example, when a relatively long dwell time is specified, the final spectrum-image data hypercube can be acquired using a single raster scan of the FOV. That is, the EDS spectrum acquired from the scan pixel location over a single dwell time goes into the final spectrum-image data hypercube as acquired, and the final spectrum-image data hypercube is gradually built, position-by-position, as the raster scan progresses toward its end. In contrast, when a relatively short dwell time is specified, multiple raster scans of the FOV are typically needed to build the final spectrum-image data hypercube because pixelwise EDS spectra corresponding to a single raster scan may not have a sufficiently high SNR. In such cases, the SNR is improved by repeating the raster scans multiple times and cumulatively adding the EDS spectra acquired in different raster scans for each pixel. In the latter example, multiple updates of the spectrum-image data hypercube are performed (for example, after each new raster scan) before the final spectrum-image data hypercube is constructed. Other ways of updating the spectrum-image data hypercube with newly measured chunks of EDS data can also be implemented in additional examples.

The method 1000 beneficially provides a capability for the user to have live preliminary elemental maps while the acquisition process is in progress. The “look” of such live preliminary elemental maps will depend on the details of the acquisition process. For example, in the “single raster scan” example described above, a preliminary elemental map will be smaller than the corresponding whole SEM image as the corresponding spectrum-image data hypercube will only have EDS data for the pixels that have been dwelled on, with the remaining pixels having no EDS data associated therewith. The latter pixels may be blacked out in the corresponding preliminary elemental map. In the “repeated raster scan” example described above, after the first raster scan, a preliminary elemental map will be of the same size as the corresponding whole SEM image. However, the accuracy of such preliminary elemental map may be relatively low due to a relatively low SNR of the accumulated EDS data. The accuracy of the subsequent preliminary elemental maps will typically improve as more and more new EDS datasets are being cumulatively added to the spectrum-image data hypercube with each new scan.

The method 1000 includes acquiring a new set of EDS spectra (in a block 1002). In some examples, the new set of EDS spectra may correspond to: (i) a partial scan line of a raster scan; (ii) one or more full scan lines of a raster scan; (iii) an arbitrarily shaped partial scan of the FOV; and (iv) one or more full scans of the FOV. Other configurations of the new set of EDS data may also be used in additional examples.

The method 1000 also includes updating the spectrum-image data hypercube (in a block 1004). This update is performed in the block 1004 using the new set of EDS data acquired in the block 1002. In some examples, such an update may include filling a vacant (empty) position in the spectrum-image data hypercube with a newly acquired EDS spectrum or adding a newly acquired EDS spectrum to the cumulative EDS spectrum previously stored in the corresponding position of the spectrum-image data hypercube.

The updated spectrum-image data hypercube produced in the block 1004 is then provided as the input 601 to the method 600, which may be run in the background of the acquisition process (also see FIG. 6). Based on the received input 601, the method 600 generates one or more preliminary elemental maps of the sample S as described above.

As illustrated in FIG. 10, a decision block 1006 is used to control the termination of the method 1000. When the electronic controller 150 determines that the data acquisition process is completed (“Yes” at the decision block 1006), the method 1000 is terminated. When the electronic controller 150 determines that the data acquisition process is not yet completed (“No” at the decision block 1006), operations of the method 1000 are looped back to the block 1002.

FIG. 11 is a block diagram of an example computing device 1100 configured to perform at least some scientific-instrument support operations in accordance with various embodiments. For example, in some embodiments, the computing device 1100 is the electronic controller 150 or performs at least some operations of the electronic controller 150. In various embodiments, a support module of the scientific instrument 100 may be implemented by a single computing device 1100 or by multiple computing devices 1100.

The computing device 1100 of FIG. 11 is illustrated as having a number of components, but any one or more of these components may be omitted or duplicated, as suitable for the application and setting. In some embodiments, some or all of the components included in the computing device 1100 may be attached to one or more motherboards and enclosed in a housing. In some embodiments, some of those components may be fabricated onto a single system-on-a-chip (SoC) (e.g., the SoC may include one or more electronic processing devices 1102 and one or more storage devices 1104). Additionally, in various embodiments, the computing device 1100 may not include one or more of the components illustrated in FIG. 11, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 1100 may not include a display device 1110, but may include display device interface circuitry (e.g., a connector and driver circuitry) to which an external display device 1110 may be coupled.

The computing device 1100 includes a processing device 1102 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 1102 may include one or more digital signal processors (DSPs), application-specific integrated circuits (ASICs), central processing units (CPUs), graphics processing units (GPUs), server processors, or any other suitable processing devices.

The computing device 1100 also includes a storage device 1104 (e.g., one or more storage devices). In various embodiments, the storage device 1104 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 1104 may include memory that shares a die with the processing device 1102. In such an embodiment, the memory may be used as cache memory and include embedded dynamic random-access memory (eDRAM) or spin transfer torque magnetic random-access memory (STT-MRAM), for example. In some embodiments, the storage device 1104 may include non-transitory computer readable media having instructions thereon that, when executed by one or more processing devices (e.g., the processing device 1102), cause the computing device 1100 to perform any appropriate ones of the methods disclosed herein below or portions of such methods.

The computing device 1100 further includes an interface device 1106 (e.g., one or more interface devices 1106). In various embodiments, the interface device 1106 may include one or more communication chips, connectors, and/or other hardware and software to govern communications between the computing device 1100 and other computing devices. For example, the interface device 1106 may include circuitry for managing wireless communications for the transfer of data to and from the computing device 1100. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 1106 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 1106 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 1106 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 1106 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 1106 may include one or more antennas (e.g., one or more antenna arrays) configured to receive and/or transmit wireless signals.

In some embodiments, the interface device 1106 may include circuitry for managing wired communications, such as electrical, optical, or any other suitable communication protocols. For example, the interface device 1106 may include circuitry to support communications in accordance with Ethernet technologies. In some embodiments, the interface device 1106 may support both wireless and wired communication, and/or may support multiple wired communication protocols and/or multiple wireless communication protocols. For example, a first set of circuitry of the interface device 1106 may be dedicated to shorter-range wireless communications such as Wi-Fi or Bluetooth, and a second set of circuitry of the interface device 1106 may be dedicated to longer-range wireless communications such as global positioning system (GPS), EDGE, GPRS, CDMA, WiMAX, LTE, EV-DO, or others. In some other embodiments, a first set of circuitry of the interface device 1106 may be dedicated to wireless communications, and a second set of circuitry of the interface device 1106 may be dedicated to wired communications.

The computing device 1100 also includes battery/power circuitry 1108. In various embodiments, the battery/power circuitry 1108 may include one or more energy storage devices (e.g., batteries or capacitors) and/or circuitry for coupling components of the computing device 1100 to an energy source separate from the computing device 1100 (e.g., to AC line power).

The computing device 1100 also includes a display device 1110 (e.g., one or multiple individual display devices). In various embodiments, the display device 1110 may include any visual indicators, such as a heads-up display, a computer monitor, a projector, a touchscreen display, a liquid crystal display (LCD), a light-emitting diode display, or a flat panel display.

The computing device 1100 also includes additional input/output (I/O) devices 1112. In various embodiments, the I/O devices 1112 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment of the scientific instrument 100 and/or of the instrument portion 200, various components of the interface devices 1106 and/or I/O devices 1112 can be configured to output suitable control signals (e.g., 152, 154, 156) for various components of the scientific instrument 100, receive suitable control/telemetry signals from various components of the scientific instrument 100, and receive streams of measurements (e.g., 162, 172, 182) from various detectors of the scientific instrument 100. In some examples, the interface devices 1106 and/or I/O devices 1112 include one or more analog-to-digital converters (ADCs) for transforming received analog signals into a digital form suitable for operations performed by the processing device 1102 and/or the storage device 1104. In some additional examples, the interface devices 1106 and/or I/O devices 1112 include one or more digital-to-analog converters (DACs) for transforming digital signals provided by the processing device 1102 and/or the storage device 1104 into an analog form suitable for being communicated to the corresponding components of the scientific instrument 100.

According to one example disclosed above, e.g., in the summary section and/or in reference to any one or any combination of some or all of FIGS. 1-11, provided is an automated method performed via a computing device for providing support to a scientific instrument, the method comprising: computing a phase map of a sample by applying phase analysis to a dataset including a charged-particle-microscope (CPM) image of the sample and a plurality of energy-dispersive X-ray spectroscopy (EDS) spectra of the sample, with each of the EDS spectra corresponding to a respective pixel of the CPM image, the phase map identifying groups of pixels representing different respective phases of the sample; for each group of the identified groups of pixels, determining a respective element set based on the EDS spectra corresponding to the group; and for a selected chemical element, computing a corresponding elemental map of the sample based on the identified groups of pixels and the determined respective element sets.

In some examples of the above method, the determining comprises: computing a respective phase spectrum by summing the EDS spectra corresponding to the group; and determining the respective element set based on the respective phase spectrum.

In some examples of any of the above methods, the determining the respective element set comprises matching sets of peaks in the respective phase spectrum to reference spectra corresponding to different elements of a periodic table of elements.

In some examples of any of the above methods, the applying comprises applying multivariate statistical analysis to the dataset to extract therefrom statistical groups representing the different respective phases of the sample.

In some examples of any of the above methods, the method further comprises displaying the corresponding elemental map on a display device.

In some examples of any of the above methods, the dataset is a final spectrum-image data hypercube previously acquired with the scientific instrument.

In some examples of any of the above methods, the corresponding elemental map is a preliminary elemental map computed while acquisition of the EDS spectra with the scientific instrument is ongoing.

In some examples of any of the above methods, the preliminary elemental map represents a smaller area than a full area of the CPM image.

In some examples of any of the above methods, the method further comprises: acquiring a new set of EDS spectra of the sample with the scientific instrument; updating the dataset with the new set of EDS spectra; and recomputing the phase map by applying the phase analysis to the updated dataset.

In some examples of any of the above methods, the new set of EDS spectra corresponds to one of: a partial scan line of a raster scan of a field of view (FOV) of the sample with the scientific instrument; one or more full scan lines of the raster scan; an arbitrarily shaped partial scan of the FOV with the scientific instrument; and one or more full scans of the FOV with the scientific instrument.

According to another example disclosed above, e.g., in the summary section and/or in reference to any one or any combination of some or all of FIGS. 1-11, provided is a non-transitory computer-readable medium storing instructions that, when executed by the computing device, cause the computing device to perform operations comprising any one of the above methods.

According to yet another example disclosed above, e.g., in the summary section and/or in reference to any one or any combination of some or all of FIGS. 1-11, provided is a support apparatus for a scientific instrument, the support apparatus comprising: an interface device configured to receive a dataset including a charged-particle-microscope (CPM) image of a sample and a plurality of energy-dispersive X-ray spectroscopy (EDS) spectra of the sample, with each of the EDS spectra corresponding to a respective pixel of the CPM image; and one or more electronic processing devices configured to: compute a phase map of the sample by applying phase analysis to the dataset, the phase map identifying groups of pixels representing different respective phases of the sample; for each group of the identified groups of pixels, determine a respective element set based on the EDS spectra corresponding to the group; and for a selected chemical element, compute a corresponding elemental map of the sample based on the identified groups of pixels and the determined respective element sets.

In some examples of the above apparatus, the one or more electronic processing devices are further configured to: compute a respective phase spectrum by summing the EDS spectra corresponding to the group; and determine the respective element set based on the respective phase spectrum.

In some examples of any of the above apparatus, the one or more electronic processing devices are further configured to: match sets of peaks in the respective phase spectrum to reference spectra corresponding to different elements of a periodic table of elements; and determine the respective element set based on found matches.

In some examples of any of the above apparatus, the one or more electronic processing devices are further configured to apply multivariate statistical analysis to the dataset to extract therefrom statistical groups representing the different respective phases of the sample.

In some examples of any of the above apparatus, the apparatus further comprises a display device configured to display the corresponding elemental map.

In some examples of any of the above apparatus, the dataset is a final spectrum-image data hypercube previously acquired with the scientific instrument.

In some examples of any of the above apparatus, the one or more electronic processing devices are further configured to compute a preliminary elemental map while acquisition of the EDS spectra with the scientific instrument is ongoing.

In some examples of any of the above apparatus, the interface device is configured to receive a new set of EDS spectra of the sample; and wherein the one or more electronic processing devices are further configured to: update the dataset with the new set of EDS spectra; and recompute the phase map by applying the phase analysis to the updated dataset.

In some examples of any of the above apparatus, the new set of EDS spectra corresponds to one of: a partial scan line of a raster scan of a field of view (FOV) of the sample with the scientific instrument; one or more full scan lines of the raster scan; an arbitrarily shaped partial scan of the FOV with the scientific instrument; and one or more full scans of the FOV with the scientific instrument.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An automated method performed via a computing device for providing support to a scientific instrument, the method comprising:
computing a phase map of a sample by applying phase analysis to a dataset including a charged-particle-microscope (CPM) image of the sample and a plurality of energy-dispersive X-ray spectroscopy (EDS) spectra of the sample, with each of the EDS spectra corresponding to a respective pixel of the CPM image, the phase map identifying groups of pixels representing different respective phases of the sample;
for each group of the identified groups of pixels, determining a respective element set based on the EDS spectra corresponding to the group; and
for a selected chemical element, computing a corresponding elemental map of the sample based on the identified groups of pixels and the determined respective element sets.

2. The automated method of claim 1, wherein the determining comprises:
computing a respective phase spectrum by summing the EDS spectra corresponding to the group; and
determining the respective element set based on the respective phase spectrum.

3. The automated method of claim 2, wherein said determining the respective element set comprises matching sets of peaks in the respective phase spectrum to reference spectra corresponding to different elements of a periodic table of elements.

4. The automated method of claim 1, wherein the applying comprises applying multivariate statistical analysis to the dataset to extract therefrom statistical groups representing the different respective phases of the sample.

5. The automated method of claim 1, further comprising displaying the corresponding elemental map on a display device.

6. The automated method of claim 1, wherein the dataset is a final spectrum-image data hypercube previously acquired with the scientific instrument.

7. The automated method of claim 1, wherein the corresponding elemental map is a preliminary elemental map computed while acquisition of the EDS spectra with the scientific instrument is ongoing.

8. The automated method of claim 7, wherein the preliminary elemental map represents a smaller area than a full area of the CPM image.

9. The automated method of claim 7, further comprising:
acquiring a new set of EDS spectra of the sample with the scientific instrument;
updating the dataset with the new set of EDS spectra; and
recomputing the phase map by applying the phase analysis to the updated dataset.

10. The automated method of claim 9, wherein the new set of EDS spectra corresponds to one of:
a partial scan line of a raster scan of a field of view (FOV) of the sample with the scientific instrument;
one or more full scan lines of the raster scan;
an arbitrarily shaped partial scan of the FOV with the scientific instrument; and
one or more full scans of the FOV with the scientific instrument.

11. A non-transitory computer-readable medium storing instructions that, when executed by the computing device, cause the computing device to perform operations comprising the automated method of claim 1.

12. A support apparatus for a scientific instrument, the support apparatus comprising:
an interface device configured to receive a dataset including a charged-particle-microscope (CPM) image of a sample and a plurality of energy-dispersive X-ray spectroscopy (EDS) spectra of the sample, with each of the EDS spectra corresponding to a respective pixel of the CPM image; and
one or more electronic processing devices configured to:
compute a phase map of the sample by applying phase analysis to the dataset, the phase map identifying groups of pixels representing different respective phases of the sample;
for each group of the identified groups of pixels, determine a respective element set based on the EDS spectra corresponding to the group; and
for a selected chemical element, compute a corresponding elemental map of the sample based on the identified groups of pixels and the determined respective element sets.

13. The support apparatus of claim 12, wherein the one or more electronic processing devices are further configured to:
compute a respective phase spectrum by summing the EDS spectra corresponding to the group; and
determine the respective element set based on the respective phase spectrum.

14. The support apparatus of claim 13, wherein the one or more electronic processing devices are further configured to:
match sets of peaks in the respective phase spectrum to reference spectra corresponding to different elements of a periodic table of elements; and
determine the respective element set based on found matches.

15. The support apparatus of claim 12, wherein the one or more electronic processing devices are further configured to apply multivariate statistical analysis to the dataset to extract therefrom statistical groups representing the different respective phases of the sample.

16. The support apparatus of claim 12, further comprising a display device configured to display the corresponding elemental map.

17. The support apparatus of claim 12, wherein the dataset is a final spectrum-image data hypercube previously acquired with the scientific instrument.

18. The support apparatus of claim 12, wherein the one or more electronic processing devices are further configured to compute a preliminary elemental map while acquisition of the EDS spectra with the scientific instrument is ongoing.

19. The support apparatus of claim 18,
wherein the interface device is configured to receive a new set of EDS spectra of the sample; and
wherein the one or more electronic processing devices are further configured to:
update the dataset with the new set of EDS spectra; and
recompute the phase map by applying the phase analysis to the updated dataset.

20. The support apparatus of claim 18, wherein the new set of EDS spectra corresponds to one of:
a partial scan line of a raster scan of a field of view (FOV) of the sample with the scientific instrument;
one or more full scan lines of the raster scan;
an arbitrarily shaped partial scan of the FOV with the scientific instrument; and
one or more full scans of the FOV with the scientific instrument.
